(19) United States
(12) Patent Application Publication
(10) Pub. No.: US 2024/0334910 A1
(43) Pub. Date: Oct. 10, 2024

(54) PET RECOVERY CONE HARNESS DEVICE

(71) Applicant: Dana Prather, Brownfield, TX (US)

(72) Inventor: Dana Prather, Brownfield, TX (US)

(21) Appl. No.: 18/363,305

(22) Filed: Aug. 1, 2023

Related U.S. Application Data
(60) Provisional application No. 63/494,047, filed on Apr. 4, 2023.

(51) Int. Cl. A61F 5/37; A01K 13/00; A01K 27/00

(52) U.S. Cl. CPC A61F 5/3707; A01K 13/006; A01K 27/002

(57) ABSTRACT

A pet recovery cone harness is disclosed that features a cone to prevent pets from licking, biting, or otherwise interfering with their healing wounds. The pet recovery cone harness device is water resistant and water repellent, comprising a harness component and a cone component that is both protective and comfortable for the animal. The harness component comprises half of a zipper for removable attachment of the cone component, a secure and adjustable hook and loop closure, two front paw holes for a secure fit, and a D loop for attachment of a leash or lead. The cone component comprises the other half of the zipper for removable attachment to the harness component, as well as a hook and loop cone closure to form the shape of the recovery cone.

### CROSS-REFERENCE TO RELATED APPLICATION

The present application claims priority to, and the benefit of, U.S. Provisional Application No. 63/494,047, which was filed on Apr. 4, 2023, and is incorporated herein by reference in its entirety.

### FIELD OF THE INVENTION

The present invention relates generally to the field of pet harnesses. More specifically, the present invention relates to an improved pet harness that features a comfortable and secure recovery cone device designed to inhibit animals from licking or otherwise disturbing the healing process of an incision or wound site. Accordingly, the present disclosure makes specific reference thereto. Nonetheless, it is to be appreciated that aspects of the present invention are also equally applicable to other like applications, devices, and methods of manufacture.

### BACKGROUND

Generally, pets who suffer from lesions or wounds resulting from an injury or a surgical procedure are given an Elizabethan collar, or “E collar”, to prevent the pet from interfering with the healing process of a wound via licking or biting. Additionally, traditional E collars are known to be uncomfortable for pets. E Collars are often heavy and may feature rough or sharp plastic edges. In addition, E Collars have little ability to bend when the animal is lying down. Further, traditional E collars are often not securely fastened around an animal, making it easy for the animal to remove the collar and interfere with a wound.

Therefore, there exists a long-felt need in the art for a pet harness that provides a softly padded recovery cone for a recovering pet. There is also a long-felt need in the art for a pet harness that features a sturdy but flexible, removable recovery cone that is both protective and comfortable. Further, there exists a long-felt need in the art for a pet harness that features a recovery cone that is lightweight and does not interfere with the pet's normal activities. Moreover, there exists a long-felt need in the art for a water-repellant and water-resistant recovery cone pet harness that allows the animal to remain clean and dry. Further, exists is a long-felt need in the art for a recovery cone pet harness that features a secure and adjustable Velcro closure. Finally, there exists a long-felt need in the art for a pet harness that features two front paw holes allowing for ease of attachment and a secure fit.

The subject matter disclosed and claimed herein, in one embodiment thereof, comprises a pet recovery cone harness device. The device is comprised of a pet harness that covers the front half of a pet's torso. More specifically, a harness component of the device is placed around a pet's torso and, a cone component that encompasses the head and neck of the pet. The harness component features two front paw holes for easy application and an adjustable hook and loop fastener for secure attachment near the pet's shoulder area. The cone component is removably attachable via at least one fastener zipper and is preferably comprised of a flexible nylon fabric that is both protective and comfortable. The cone is lightweight and softly padded for additional comfort. The cone component is also water-repellent, and water-resistant.

In this manner, the pet recovery cone harness of the present invention accomplishes all of the foregoing objectives and provides pets with a protective yet comfortable healing assistance device. The harness promotes healing by preventing the animal from biting or licking its wounds or other lesions, which interferes with the recovery process.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a pet recovery cone harness device. The pet recovery cone harness device features a cone to prevent pets from licking, biting, or otherwise interfering with their healing wounds while the device is worn. The pet recovery cone harness device is water resistant and water repellent, comprising a harness component and a cone component that is both protective and comfortable for an animal. The harness component comprises at least one fastener for removable attachment of the cone component, a secure and adjustable hook and loop closure, two front paw holes for a secure fit, and a D loop for attachment of a leash or lead.

In one embodiment, the pet recovery cone harness device comprises a harness component and a cone portion. The harness component is typically flat in shape and features two openings for the front legs of the animal. When attached to the animal, the harness component covers the torso and shoulder area in a cylindrical fashion and features a closure mechanism near the shoulder of the animal.

In one embodiment, the cone component is removably attached to the harness component. This allows the user to convert the pet recovery cone harness into a regular harness once the pet has recovered. Typically, the neck end of the harness component is the same diameter as the neck end of the cone portion, so that once attached via at least one fastener, the base component is flush with the cup portion. Although at least one fastener attaches the cone portion to the harness component, any fastener deemed suitable for the purpose described may be used.

In one embodiment, the harness component is secured around the animal's torso with an adjustable fastener closure near the animal's shoulder. This ensures a snug and secure fit regardless of the size of the animal.

In one embodiment, the harness component features two holes for the animal's front paws and front legs to pass through for ease of attachment.

In another embodiment, the pet recovery cone harness is comprised of a water-resistant and water-repellent material, allowing the animal to remain clean and dry.

In one embodiment, the harness component features a metal D loop on the back of the animal for attachment of a leash or lead. Although it is proposed that the D loop is manufactured with metal, any material deemed suitable for leash or lead attachment may be used.

In one embodiment, the cone component is comprised of a cone-shaped piece of nylon fabric. The fabric used is sturdy but flexible, as well as lightweight to provide maximum comfort.

In another embodiment, the cone component features a Velcro fastener to ensure the cone does not come apart.

In yet another embodiment, the pet recovery cone harness comprises a plurality of indicia.

In yet another embodiment, a method of assembling and securing the pet recovery cone harness on an animal is disclosed. The method comprises providing a pet recovery cone harness comprising a harness component and a cone component. The method also comprises attaching the cone component to the harness component using at least one fastener. Further, the method comprises placing the pet's front legs into the holes in the harness component. The method also comprises wrapping the harness component around the pet's torso and securing it with a harness fastener. Finally, the method comprises closing the cone component using a cone fastener.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side perspective view of one embodiment of the pet recovery cone harness device of the present invention fully assembled and secured to an animal in accordance with the disclosed architecture;

FIG. 2 illustrates a side perspective view of one embodiment of the fully assembled pet recovery cone harness device of the present invention in accordance with the disclosed architecture;

FIG. 3 illustrates an overhead perspective view of one embodiment of the pet recovery cone harness device of the present invention showing the harness component and cone component detached and laid flat in accordance with the disclosed architecture; and

FIG. 4 illustrates a flowchart showing the method of assembling and securing the pet recovery cone harness on an animal in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not show all the aspects or advantages. Thus, in other embodiments, any of the features described herein from different embodiments may be combined.

As noted above, there exists a long-felt need in the art for a pet harness that provides a softly padded recovery cone to provide comfort to recovering pets. There is also a long-felt need in the art for a pet harness that features a sturdy but flexible, removable recovery cone that is both protective and comfortable. Further, there is a long-felt need in the art for a pet harness that features a recovery cone that is lightweight and does not interfere with the pet's normal activities. Moreover, there is a long-felt need in the art for a water-repellant and water-resistant recovery cone pet harness that allows the animal to remain clean and dry. Further, there is a long-felt need in the art for a recovery cone pet harness that features a secure and adjustable Velcro closure. Finally, there is a long-felt need in the art for a pet harness that features two front paw holes allowing for ease of attachment and a secure fit.

The present invention, in one exemplary embodiment, is a novel pet recovery cone harness device. The device is a pet harness that covers the front half of a pet's torso. The pet recovery cone harness comprises a harness component that is placed around the pet's torso and a cone component that encompasses the head and neck of the animal. The harness component features two front paw holes for easy application, and an adjustable fastener for secure attachment near the animal's shoulder area. The cone component is removably attachable via a fastener and consists of a sturdy but flexible nylon fabric that is both protective and comfortable. The cone is lightweight and softly padded for additional comfort. The cone component is also water-repellent, and water-resistant.

The present invention also includes a method of assembling and securing the pet recovery cone harness on an animal. In yet another embodiment, a method of assembling and securing the pet recovery cone harness on an animal is disclosed. The method comprises providing a pet recovery cone harness comprising a harness component and a cone component. The method also comprises attaching the cone component to the harness component using the zipper fastener. Further, the method comprises placing the pet's front legs into the holes in the harness component. The method also comprises wrapping the harness component around the pet's torso and securing it with the harness fastener. Finally, the method comprises closing the cone component using the cone fastener.

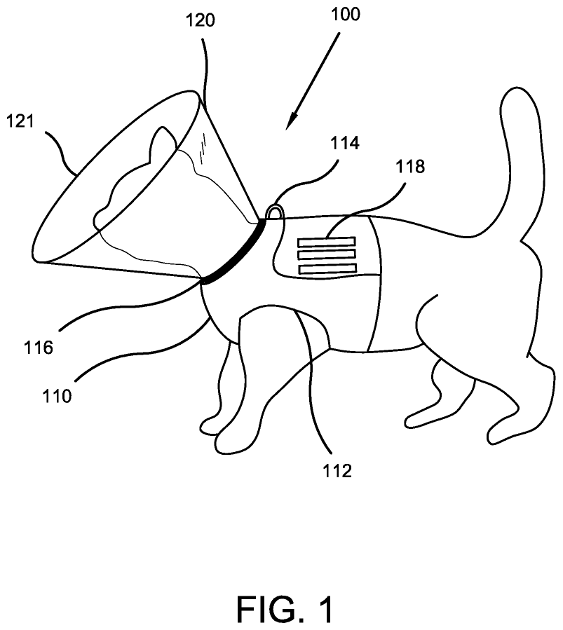

Referring initially to the drawings, FIG. 1 illustrates a side perspective view of one embodiment of the pet recovery cone harness device of the present invention fully assembled and secured to an animal. In the present embodiment, the pet recovery cone harness device 100 is an improved pet harness that includes a cone to prevent animals from licking, biting, or otherwise interfering with healing wounds.

More specifically, the pet recovery cone harness device 100 comprises a harness component 110 attached to a cone component 120 via at least one fastener 116 such as, but not limited to, a zipper. The harness component 110 comprises at least one (but preferably two) front paw holes 112, at least one D loop 114 (or other leash attachment fastener of the like), and an adjustable harness fastener 118 that is preferably, but not limited to a hook and loop fastener.

Both the harness component 110 and the cone component 120 can be made of the same material, preferably, but not limited to, lightweight nylon or another synthetic fabric. Generally, the harness component 110 and the cone component 120 can be made of any suitable materials that meet the needs and/or wants of a user. Furthermore, the harness component 110 can be shaped and sized to resemble a typical pet harness known in the art for any animal type.

The harness component 110 preferably has two front paw holes 112 for the front legs of the animal. When attached to the animal, the harness component 110 covers the torso and shoulder area of the animal in a cylindrical fashion. The harness 110 is comprised of at least one adjustable harness fastener 118 preferably, but not limited to, a hook and loop fastener, near the shoulder of the animal that allows the harness 110 to be tightened/loosened around the animal. Additionally, the harness component 110 can be any suitable shape and size as is known in the art and can further be manufactured in various shapes and sizes, depending on the needs and/or wants of a user.

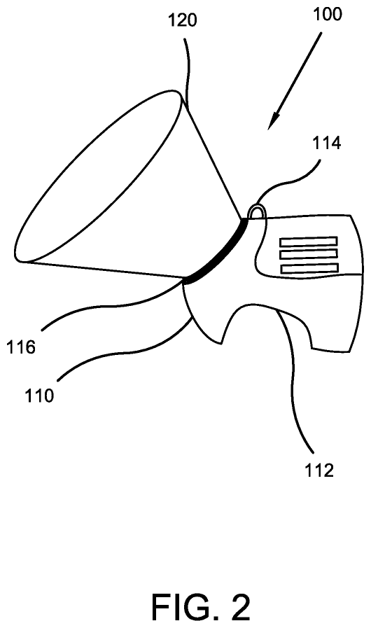

FIG. 2 illustrates a side perspective view of one embodiment of the fully assembled pet recovery cone harness device 100. The front paws of an animal can be placed through the front paw holes 112 for easy attachment of the harness component 110. The D loop 114 can be used to attach a leash or lead to the harness component 110. The adjustable harness fastener 118 is used to secure the harness component 110 around the animal's torso.

The cone component 120 is comprised of at least one cone fastener 122 that is preferably a hook and loop fastener which allows the cone 120 to be secured to itself to form a cone shape around the head of an animal. The two halves of the zipper 116 can be joined to removably attach the harness component 110 to the cone component 120. This removable attachment method is particularly useful after the animal has healed, as the harness component 110 can then be used as a traditional pet harness. The cone 120 is preferably comprised of a flexible material (for pet comfort) and rounded edges 121 to prevent injury to a pet from the cone 120.

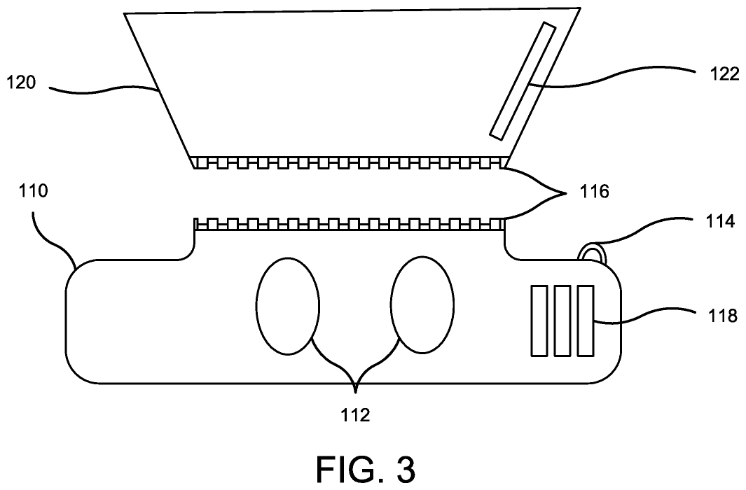

FIG. 3 illustrates an overhead perspective view of one embodiment of the pet recovery cone harness device 100 of the present invention showing the harness component 110 and cone component 120 detached and laid flat. FIG. 3 also illustrates an embodiment in which a cone fastener 122 is used to form the shape of the cone component 120.

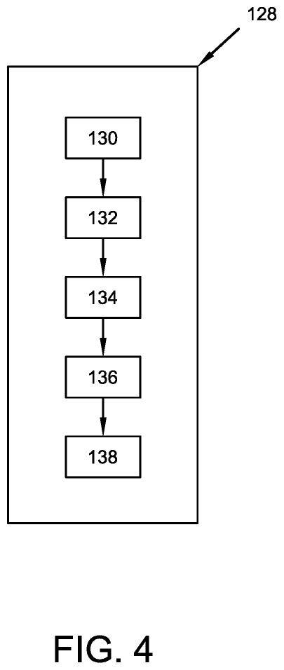

FIG. 4 illustrates a flowchart showing the method 128 of assembling and securing the pet recovery cone harness on an animal. First, a pet recovery cone harness is provided comprising a harness component 110 and a cone component 120 that attaches to the harness component 110 [Step 130]. Then, the cone component 120 is attached to the harness component 110 using a zipper fastener 116 [Step 132]. Next, a pet's front legs can be placed into the holes 112 in the harness component 110 [Step 134]. Then, the harness component 110 can be placed around the pet's torso and secured around the pet's torso via a harness fastener 118 [Step 136]. Finally, the cone 120 can be closed around a pet's head using the cone fastener 122 [Step 138].

Certain terms are used throughout the following description and claims to refer to particular features or components. As one skilled in the art will appreciate, different users, may refer to the same feature or component by different names. This document does not intend to distinguish between components or features that differ in name but not structure or function. As used herein “pet recovery cone harness device”, “recovery cone harness device”, “pet recovery device” and “device” are interchangeable and refer to the pet recovery cone harness device 100 of the present invention.

Notwithstanding the foregoing, the pet recovery cone harness device 100 of the present invention can be of any suitable size and configuration as is known in the art without affecting the overall concept of the invention, provided that it accomplishes the above-stated objectives. One of ordinary skill in the art will appreciate the pet recovery cone harness device 100 as shown in FIGS. 1-4 is for illustrative purposes only, and many other sizes and shapes of the pet recovery cone harness device 100 are well within the scope of the present disclosure. Although the dimensions of the pet recovery cone harness device 100 are important design parameters for user convenience, the pet recovery cone harness device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A pet recovery cone harness device comprising:
a harness having an opening; and
a cone that attaches to the harness via a fastener.

2. A pet recovery cone harness device of claim 1, wherein the harness is comprised of a D loop.

3. A pet recovery cone harness device of claim 1, wherein the cone is comprised of a cone fastener.

4. A pet recovery cone harness device of claim 3, wherein the cone fastener is comprised of a hook and loop fastener.

5. A pet recovery cone harness device of claim 1, wherein the fastener is comprised of a zipper fastener.

6. A pet recovery cone harness device of claim 1, wherein the harness is comprised of a pet harness.

7. A pet recovery cone harness device of claim 1, wherein the harness is comprised of a nylon material.

8. A pet recovery cone harness device of claim 1, wherein the cone is comprised of a flexible material.

9. A pet recovery cone harness device of claim 1, wherein the cone is comprised of a rounded edge.

10. A pet recovery cone harness device of claim 1 further comprising a second fastener and a third fastener.

11. A pet recovery cone harness device comprising:
a harness having an opening;
a harness fastener; and
a cone comprised of a cone fastener, wherein the cone attaches to the harness via an attachment fastener.

12. A pet recovery cone harness device of claim 11, wherein the harness fastener is comprised of a hook and loop fastener.

13. A pet recovery cone harness device of claim 11, wherein the cone fastener is comprised of a hook and loop fastener.

14. A pet recovery cone harness device of claim 11, wherein the attachment fastener is comprised of a zipper fastener.

15. A pet recovery cone harness device of claim 11, wherein the harness is comprised of a pet harness.

16. A pet recovery cone harness device of claim 11, wherein the harness is comprised of a nylon material.

17. A pet recovery cone harness device of claim 11, wherein the cone is comprised of a flexible material.

18. A pet recovery cone harness device of claim 11, wherein the cone is comprised of a rounded edge.

19. A method of using a pet recovery cone harness device, the method comprising:
providing a pet recovery cone harness device comprised of a harness component and a cone component that attaches to the harness component;
attaching the cone component to the harness component via a first fastener;
placing a pet's front leg into a hole of the harness component;
placing the harness component around a torso of the pet and securing the harness component in said position via a second fastener; and
closing the cone component around a head of the pet via a third fastener.

20. A method of using a pet recovery cone harness device of claim 19, wherein the first fastener is comprised of a zipper.
